(19) United States
(12) Patent Application Publication
(10) Pub. No.: US 2008/0294724 A1
(43) Pub. Date: Nov. 27, 2008

(54) METHOD AND TOOL FOR COMMUNITY-BASED PHYSICAL LOCATION AWARENESS

(76) Inventors: Margaret A. Strong, Newnan, GA (US); Albert T. Wong, Hacienda Heights, CA (US)

Correspondence Address: HOFFMAN WARNICK LLC, 75 STATE ST, 14TH FLOOR, ALBANY, NY, 12207, US

(21) Appl. No.: 11/753,724

(22) Filed: May 25, 2007

(51) Int. Cl. G06F 15/16

(52) U.S. Cl. 709/205

(57) ABSTRACT

A solution for enhancing awareness of physical location within a community is provided. A method may include detecting a device affiliated with a member of the community, when the device is within a specified proximity to a user; and notifying the user of the detection of the member within the specified proximity. In one embodiment, a system for applying the method is disclosed. In one application, a location awareness enhancement (e.g., community locating) program is also disclosed.

### FIELD OF THE INVENTION

The invention relates generally to ways for improving knowledge as to the whereabouts of other persons and/or devices, and more particularly, to a method and tool for community-based physical location awareness.

### BACKGROUND OF THE INVENTION

Corporate workers are working more frequently in a virtual world, wherein business relationships are forged only through email, teleconferences, and Web meetings. Less and less chance remains to foster business relationships by chance meetings at the proverbial water cooler, in the lobby, or at the elevator. The benefits of information exchange that has occurred in these traditional office settings through chance meetings has been lost.

To counter this loss, great interest has been shown in virtual communities of practice: groups of practitioners that band together with a common work mission to support the goals of the business and interact virtually at a business level. These communities of practice synthesize the social business interaction that can be missing in a mobile setting, and many mobile practitioners cite participation in these communities of practice as a necessary activity to “stay connected” with the mainstream culture of the company. However, mobile groups of practitioners have no way of synthesizing the “chance” meetings that so often result in relationship building, information exchange, and serendipitous business opportunity because the virtual work world cloaks the necessity of physically tracking a practitioner's where-a-bouts. We know how to contact people; we even know that they are available for chats because they are online. But we never know if they are physically right around the corner or on the other coast of the country. As such, we can miss a valuable and rare face-to-face interaction because we don't have this knowledge.

Two examples of a typical instant messaging exchange and a mobile device exchange that highlight these shortcomings are as follows:
Background of Example 1: Two virtual workers who are working online.
PS: “Hello Albert—sorry I didn't get back to you. I was in meetings in NY
Tuesday-Thursday last week.”
AW: “NY?? Where were you??”
PS: “Somers”
AW: “Somers??!!?? What building? I was in Building 4 on Tues. and Wed.”
PS: “Incredible. I was in Building 2—had I known you were so close, we could have worked on this together in person while we were there.”

Example 2: 10,000+tech conference attendants are moving from conference room to conference room in multiple hotels and conference and convention centers, up and down the strip in Las Vegas. Most attendants are walking with a mobile device in hand where it is common to hear communication such as the following:
AW: “I'm in Las Vegas at this conference.” “Are you here?” “OK, I'm going into the XYZ Hotel now.” “How close are you?”<pause>“Where's that?” “Will you be in such and such a session?” “How can I meet you if I don't know what you look like?”

In view of the foregoing, a need exists to overcome one or more of the deficiencies in the related art.

### SUMMARY OF THE INVENTION

The present invention relates to a method, system, and a computer program stored on a computer-readable medium, for enhancing community-based physical location awareness. A solution for enhancing awareness of physical location within a community is provided. A method may include detecting a device affiliated with a member of the community, when the device is within a specified proximity to a user; and notifying the user of the detection of the member within the specified proximity. In one embodiment, a system for applying the method is disclosed. In one application, a location awareness enhancement (e.g., community locating) program is also disclosed.

A first aspect of the present invention is directed to a method of enhancing awareness of physical location within a community, the method comprising: detecting a device affiliated with a member of the community, when the device is within a specified proximity to a user; and notifying the user of the detection of the member within the specified proximity.

A second aspect of the present invention is directed to a system for enhancing awareness of physical location within a community, the system comprising: a detection system for detecting a device affiliated with a member of the community, when the device is within a specified proximity to a user; and a notification system for notifying the user of the detection of the member within the specified proximity.

A third aspect of the present invention is directed to a program product stored on a computer readable medium, which when executed, enables a computer system to enhance awareness of physical location within a community, the computer readable medium comprising program code for: detecting a device affiliated with a member of the community, when the device is within a specified proximity to a user; and notifying the user of the detection of the member within the specified proximity

A fourth aspect of the present invention is directed to a method for deploying an application for enhancing awareness of physical location within a community, comprising: providing a computer infrastructure being operable to: detect a device affiliated with a member of the community, when the device is within a specified proximity to a user; and notify the user of the detection of the member within the specified proximity.

A fifth aspect of the invention provides computer software embodied in a propagated signal for enhancing awareness of physical location within a community, the computer software comprising instructions to cause a computer system to perform the following functions: detecting a device affiliated with a member of the community, when the device is within a specified proximity to a user; and notifying the user of the detection of the member within the specified proximity.

A sixth aspect of the present invention is directed to a business method for enhancing awareness of physical location within a community, the business method comprising managing a computer system that performs the process described herein; and receiving payment based on the managing.

The illustrative aspects of the present invention are designed to solve the problems herein described and other problems not discussed.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts an illustrative scenario involving a community implementing embodiment(s) of the present invention.

FIG. 2 depicts a close-up of a portion of the scenario of FIG. 1 in accordance with an embodiment of the present invention.

FIG. 3 depicts a graphical user interface (GUI) for aiding the implementation of embodiment(s) of the present invention.

FIG. 4 depicts a flow diagram of an illustrative process in accordance with an embodiment of the present invention.

FIG. 5 depicts an illustrative system for implementing embodiment(s) of the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

Aspects of the present invention include employing pervasive wireless technologies to validate the presence of business community members or other individuals as defined by a user. Embodiments of the present invention address the deficiencies brought forward by the examples provided above: in other words, it provides an opportunity for community practitioners to pervasively alert one another that they are in proximity to each other. Aspects of the present invention bridge the social business relationships that are created in the virtual world and assist the perpetuation of them to the physical world.

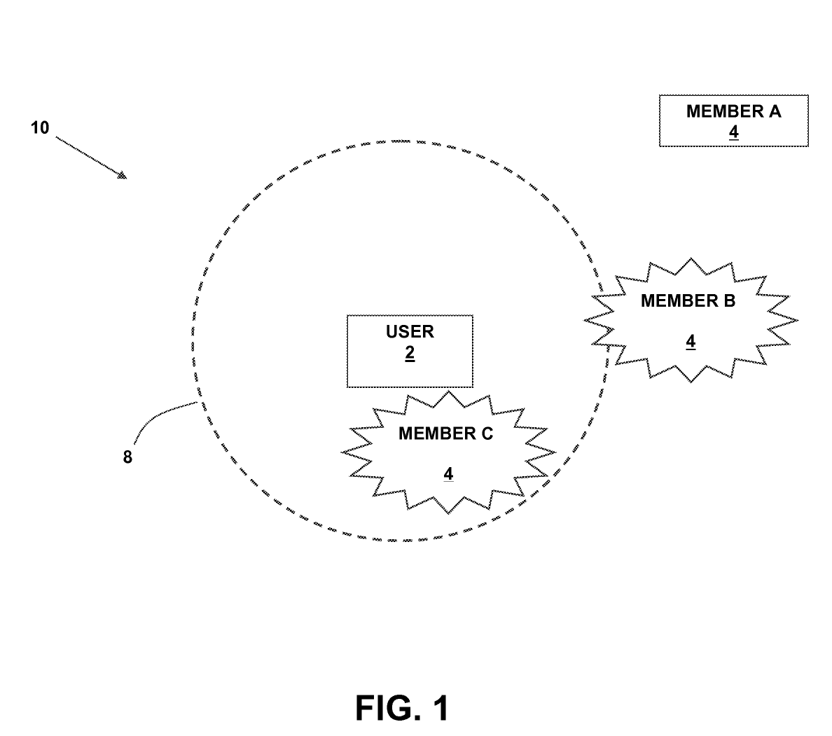

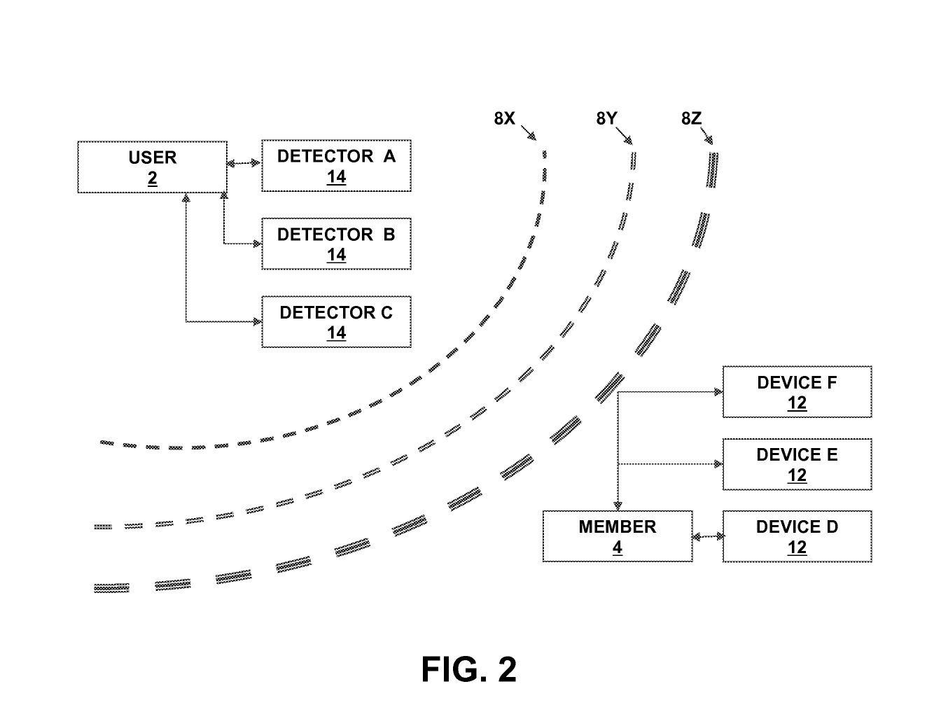

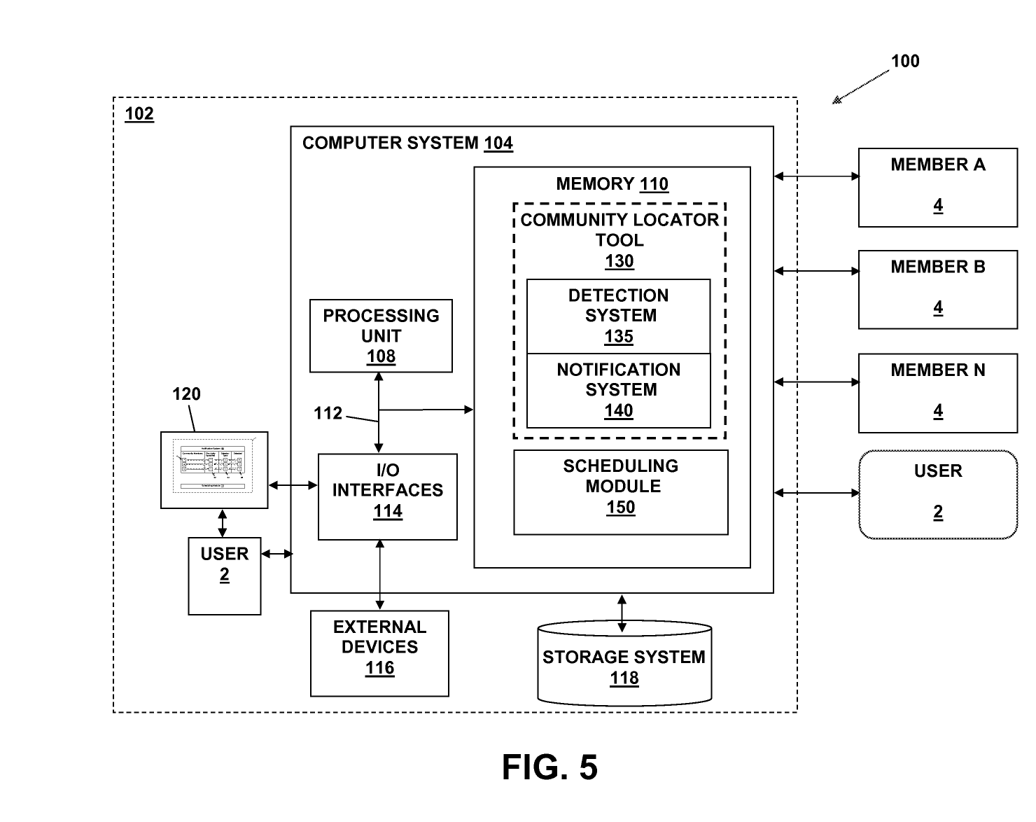

As depicted in FIG. 1, an illustrative scenario 10 involving a community implementing an embodiment of the present invention includes a user 2 and at least one member 4 of the community. The user 2, employing aspects of the present invention including a community locator tool 130 (FIG. 5), is able to specify a proximity 8 around the user 2 for detecting the member 4 and/or a device 12 affiliated with the member 4 of the community upon the member 4 and/or the device 12 being within the specified proximity 8 to the user 2. The user 2 is notified of the detection of the member 4 and/or the device 12 (FIG. 2) being within the specified proximity.

Clearly, the community may be made up of one, two, or a near infinite quantity of members 4. Similarly, the user 2, though often and typically a member 4, need not be a member 4 of the community. The user 2, as with the member(s) 4, so too may be a plurality of users 2 employing aspects of the present invention. In the scenario 10 shown, the community includes four members 4 (“Member A”, “Member B”, “Member C”, and user 2. As shown, member B 4 and member C 4 are detected for being within the specified proximity 8 of user 2, while member A 4 remains undetected for being beyond the specified proximity 8 of user 2. While member C 4 is well within the specified proximity 8 of the user 2 (i.e., detected), member B 4 is instantly being detected as immediately crossing the specified boundary 8.

Turning to FIG. 2, which depicts a close-up view of a portion of the scenario 10, it is clear that the specified proximity 8 may be user selectable and variable. For example, the user 2 may select one of three different proximities (e.g., 8X, 8Y, 8Z) for use in detecting the member 4 and/or the device 12 affiliated therewith. While a first specified proximity 8X has a shortest distance to the user 2, and a second specified proximity 8Y has a medium distance to the user 2, a third specified proximity 8Z has a longest distance to the user 2. Further, user 2 may employ a detector 14 which is configured to detect the member 4 and/or device 12 affiliated therewith. Different detectors 14 (e.g., “Detector A”, “Detector B”, “Detector C”) may be used by user 2 wherein each detector 14 provides different attributes. For example, detector A 14 may only provide the first specified proximity 8X capability (i.e., shortest), detector B 14 may provide the second specified proximity 8Y capability (i.e., medium), while detector C 14 may provide the third specified proximity 8Z capability (i.e., longest). Similarly, member 4 may employ devices 12 with different attributes. For example, any one of device D 12, device E 12, and/or device F 12 may be used wherein the ability to be detected and/or the distance/proximity at which the device 12 is detectable may vary.

In any event, the method and technology required for adapting existing wireless systems for location awareness of community members (e.g., business practitioners) may differ depending on the technology and circumstances, since wireless comes in different flavors. Ultimately, various wireless systems described herein, now known and/or developed in the future are employed to serve, in part, as the detector 14, the device 12, the system 100 (FIG. 5) and/or the community locator tool 130 (FIG. 5) in accordance with embodiments of the present invention. Four descriptive scenarios are described below.

### Scenario I:

A wireless local area network (WLAN) employing general packet radio service (GPRS) protocol may be employed to detect and/or notify, as in accordance with embodiments of the present invention. Using the WLAN and a subscriber identity module (SIM) card during authentication GPRS support node compares the information from the SIM card. The support node retains or transfers to a secure server (not shown) any personal data and the specified proximity 8 of detector 14 and/or device 12. As additional members 4 enter, specified proximity 8 is checked and mirrored against a database of members 4 within the same community, or expanded social network as defined by the user 2. The user 2 is notified that an individual in the database (i.e., member 4) is within the specified proximity 8.

### Scenario 2:

Wireless personal area network (WPAN), using for example a Bluetooth or other protocol, may be employed to detect and/or notify, as in accordance with embodiments of the present invention. Bluetooth is a trademark of Bluetooth SIG, Inc. in the United States, other countries, or both. These embodiments may be appropriate for enhancing in a local setting such as with meeting rooms, convention/conference centers, and the like (i.e., if local) or can be used to connect through higher level access. Program code in the community locator tool 130 (FIG. 5) configured to conduct the data exchanges may rely on preregistration or community definition (e.g., listing of members 4) supplied by the user 2.

### Scenario 3:

Radio frequency identification (RFID) technologies may be employed to detect and/or notify, as in accordance with embodiments of the present invention. For example, RFID may be employed at the detector 14 so that upon entering a facility (e.g., convention center), the detector 14 is been loaded with user's 2 information and their preference for what members 4 the user 2 would like to be notified (i.e., upon the member 4 and/or device 12 is within the specified proximity 8). If someone from the user's preference list is within the specified proximity 8, the user 2 is notified via PDA, a graphical user interface 120 (FIG. 5) on detector 14, or other communication device.

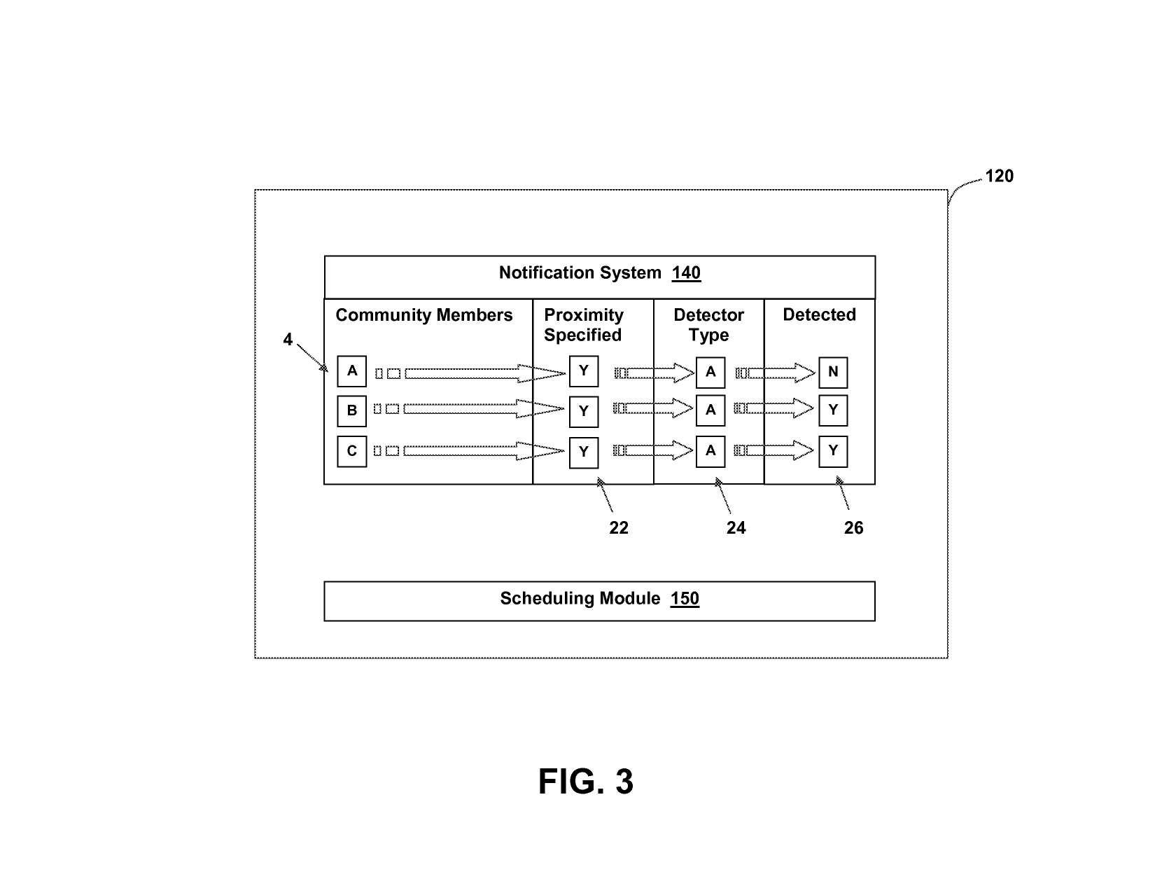

Another adaptation includes a central display (which can display different communities through a series of mouse or keyclicks) (e.g., GUI 120 at FIG. 5) to see what members 4 are within the specified proximity 8. They can then arrange meeting places through the central display GUI 120 and, for example, via a scheduling module 150 (FIG. 3). For example, orchestrated local events such as a convention—could be offered as a service by pre-existing communities such as airline frequent flyer clubs so member 4/user 2 can find other members 4 from the same organization in an airport, etc.

### Scenario 4:

A wireless local area network (WLAN) employing code division multiple access (CDMA) protocol may be employed to detect and/or notify, as in accordance with embodiments of the present invention. For example, community members 4 may pre-register via an electronic serial number (ESN), a subscriber identity module (SIM) card, and/or a smart card to enter into a community locator tool 130 (FIG. 5). During authentication, user 2 connects to a base station (not shown), which sends a random 32-bit number to the detector 14 (e.g., mobile communication device). The detector 14 then combines the random number, ESN, min and A-key to compute an authentication signature. The base station retains ESN or sends to a server (not shown). Once access to the WLAN is granted, software on the base station (or server) checks for recent access and compares to the stored database of previous communications or pre-registered community members 4 that may have been authenticated. The user 2 is then notified of community members 4 in within the specified proximity 8.

Clearly other configurations and technologies now known, or later developed, may be employed to enhance awareness of the location of members 4 of the particular community by detecting and/or notifying of the presence of another community member 4 within the specified proximity 8. Note that embodiments of the invention may also be extended to devices 12 becoming aware of other devices 12 entering the specified proximity 8. This aspect infers a whole other range of uses besides person-to-person location awareness within a social, business-based community setting.

A GUI 120 to be used at either the detector 14, device 12, and/or the central display device discussed herein is depicted in FIG. 3. The GUI 120 may include interface communication for the user 2 so as to notify the user of the detection of member(s) 4 as being within the specified proximity 8 via a notification system 140 (see also FIG. 5). Said detection indicated in the column labeled “Detected” 26 (or “detected indicator”). Thus, viewing FIG. 3 in consort with the example shown in FIG. 1, detected members 4 (i.e., Member B, Member C) have a detected indicator 26 of “Y” (for “yes”), while still undetected members 4 (i.e., Member A) has a detected indicator 26 of “N” (for “no”).

Other information available from the notification system 140 on the GUI 120 may include a listing of community members 4. Members 4 may be added, deleted, and/or edited by the user 2. As shown, members 4 (e.g., “A”, “B”, “C”) are in the selected community. Additionally, the proximity 8 (FIGS. 1, 2) may be specified via column 22 and/or 24. Clearly, other customizable and user 2 adjustable features may be available via the GUI 120.

Also available at the GUI 120 may be access to a scheduling module 150. The scheduling module 150 (see e.g., FIG. 5) may provide additional functionality to schedule a face-to-face meeting with members 4 once detected (e.g., calendar, location, resource allocation, etc.).

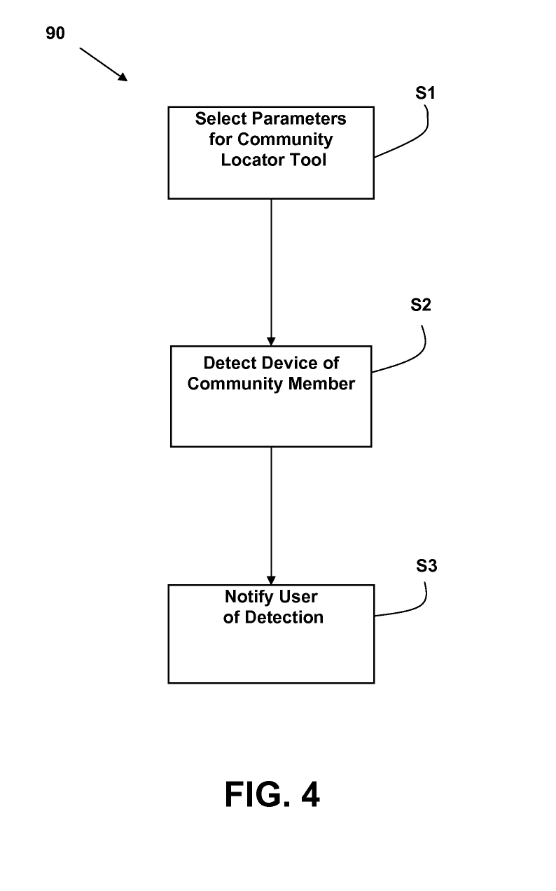

A flow diagram 90 of an illustrative process in accordance with an embodiment of the present invention is depicted in FIG. 4. In process S1, a user 2 may select various parameters for the community locator tool 130 (FIG. 5) to employ in detecting members 4 and/or notifying the user 2. These parameters may include, for example, aspects like specified proximity 8, members 4 in community, etc. Another aspect may be a selectable option of whether the user 2 wants the member 4, once detected, to be notified that he/she has, in fact, been detected by the user 2 and/or the user's detector 14.

Returning again to the flow diagram 90 depicted in FIG. 4, the detector 14 detects the device 12 affiliated with the member 4 provided in process S2 upon the device 12 being within the specified proximity 8 to a user 2. In process S3, the user 2 is notified of the detection. The notification may include notifying on the central display device, detector 14, and/or GUI 120 discussed herein.

FIG. 5 depicts an illustrative system 100 in accordance with embodiment(s) of the present invention. The system 100 includes a computer infrastructure 102 that can perform the processes described herein. The computer infrastructure 102 is shown including a computer system 104.

The computer system 104 is shown as including a processing unit 108, a memory 110, at least one input/output (I/O) interface 114, and a bus 112. Further, the computer system 104 is shown in communication with at least one external device 116 and a storage system 118. In general, the processing unit 108 executes computer program code that is stored in memory 110 and/or storage system 118. While executing computer program code, the processing unit 108 can read and/or write data from/to the memory 110, storage system 118, and/or I/O interface(s) 114. Bus 112 provides a communication link between each of the components in the computer system 104. The external device(s) 116 can comprise any device (e.g., display 120) that enables a user 6 to interact with the computer system 104 or any device that enables the computer system 104 to communicate with one or more other computer systems.

In accordance with an embodiment of the present invention, the program code stored in the memory 110 comprises a community locator tool, or tool, 130 for enhancing the awareness of the physical location within a community. Provided as part of the tool 130 is a detection system 135 for detecting device(s) 12 of members 4 of the community, and a notification system 140 for notifying the user 2 of the detecting of members 4 within specified proximity of the user 2. Also provided may be a scheduling module 150 for coordinating a meeting(s) between user 2 and member(s) 4. Optionally provided may be a selection system for allowing the selection of individual(s) to be a member 4 of the community and/or a proximity system for allowing the selection of the specified proximity 8. The operation carried out by each of these systems, tools, and/or modules is described in greater detail above.

The computer system 104 can comprise any general purpose computing article of manufacture capable of executing computer program code installed thereon (e.g., a personal computer, server, handheld device, etc.). However, it is understood that the computer system 104 and its various elements is only representative of various possible computer systems that may perform the processes of the invention. To this extent, in other embodiments, the computer system 104 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Similarly, the computer infrastructure 102 is only illustrative of various types of computer infrastructures that can be used to implement the present invention. For example, in one embodiment, the computer infrastructure 102 comprises two or more computer systems (e.g., a server cluster) that communicate over any type of wired and/or wireless communications link, such as a network, a shared memory, or the like, to perform the processes of the invention. When the communications link comprises a network, the network can comprise any combination of one or more types of networks (e.g., the Internet, a wide area network, a local area network, a virtual private network, etc.). Regardless, communications between the computer systems may utilize any combination of various types of transmission techniques.

It is understood that some of the various systems shown in FIG. 5 can be implemented independently, combined, and/or stored in memory for one or more separate computer systems that communicate over a network. Further, it is understood that some of the systems and/or functionality may not be implemented, or additional systems and/or functionality may be included as part of the system 100.

It is understood that the invention further provides various alternative embodiments. For example, in one embodiment, the invention provides a computer-readable medium that includes computer program code to enable a computer infrastructure to carry out and/or implement the processes of the present invention. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computer system, such as the memory 110 and/or storage system 118 (e.g., a fixed disk, a read-only memory, a random access memory, a cache memory, etc.), and/or as a data signal traveling over a network (e.g., during a wired/wireless electronic distribution of the program code).

In another embodiment, the invention provides a business method that performs the process steps of the invention on a subscription, advertising, and/or fee basis. A service provider can create, maintain, support, etc., a computer infrastructure, such as the computer infrastructure 102, that performs the process of the invention for one or more customers. In return, the service provider can receive payment from the customer(s) under a subscription and/or fee agreement and/or the service provider can receive payment from the sale of advertising space to one or more third parties.

In still another embodiment, a computer infrastructure, such as the computer infrastructure 102, can be obtained (e.g., created, maintained, having made available to, etc.) and one or more systems for performing the process of the invention can be obtained (e.g., created, purchased, used, modified, etc.) and deployed to the computer infrastructure. To this extent, the deployment of each system can comprise one or more of (1) installing program code on a computer system, such as the computer system 104, from a computer-readable medium; (2) adding one or more computer systems to the computer infrastructure; and (3) incorporating and/or modifying one or more existing systems of the computer infrastructure, to enable the computer infrastructure to perform the process of the invention.

As used herein, it is understood that the terms “program code” and “computer program code” are synonymous and mean any expression, in any language, code or notation, of a set of instructions intended to cause a computer system having an information processing capability to perform a particular function either directly or after either or both of the following: (a) conversion to another language, code or notation; and (b) reproduction in a different material form. To this extent, program code can be embodied as one or more types of program products, such as an application/software program, component software/a library of functions, an operating system, a basic I/O system/driver for a particular computing and/or I/O device, and the like.

The foregoing description of the preferred embodiments of this invention has been presented for purposes of illustration and description. It is not intended to be exhaustive or to limit the invention to the precise form disclosed, and obviously, many modifications and variations are possible.

What is claimed is:

1. A method of enhancing awareness of physical location within a community, the method comprising:
detecting a device affiliated with a member of the community, when the device is within a specified proximity to a user; and
notifying the user of the detection of the member within the specified proximity.

2. The method of claim 1, further comprising:
selecting at least one individual to be a member of the community.

3. The method of claim 2, wherein the selecting includes:
opting for the at least one individual to be on a list of detectable members of the community.

4. The method of claim 1, further comprising:
selecting the specified proximity for detection by the user.

5. The method of claim 1, wherein a plurality of the members of the community each have a device affiliated therewith.

6. The method of claim 1, wherein the notifying includes displaying on a central display device of the detection of the member within the specified proximity.

7. The method of claim 6, wherein the central display device is further configurable to coordinate an in-person meeting between the user and the detected member.

8. The method of claim 1, wherein the community comprises a plurality of members and wherein the members each have at least one common: employer, employment division, supervisor, membership, association, hobby, and interest.

9. The method of claim 1, wherein at least one of the detecting and notifying includes using at least one selected from a group consisting of: general packet radio service (GPRS), a code division multiple access (CDMA) protocol, radio frequency identification (RFID), a Bluetooth protocol, a subscriber identity module (SIM) card, and a smart card.

10. A system for enhancing awareness of physical location within a community, the system comprising:
a detection system for detecting a device affiliated with a member of the community, when the device is within a specified proximity to a user; and
a notification system for notifying the user of the detection of the member within the specified proximity.

11. The system of claim 10, further comprising:
a selection system for allowing selecting at least one individual to be a member of the community.

12. The system of claim 11, wherein the selection system includes:
an optioning system for allowing opting for the at least one individual to be on a list of detectable members of the community.

13. The system of claim 10, further comprising:
a proximity system for allowing selecting a specified proximity for detection by the user.

14. The system of claim 10, wherein a plurality of the members of the community each have a device affiliated therewith.

15. The system of claim 10, wherein the notification system includes a central display device for displaying the detection of the member within the specified proximity.

16. The system of claim 15, wherein the central display device is further configurable to coordinate an in-person meeting between the user and the detected member.

17. The system of claim 10, wherein the community comprises a plurality of members and wherein the members each have at least one common: employer, employment division, supervisor, membership, association, hobby, and interest.

18. The system of claim 10, wherein at least one of the detection system and the notification system uses at least one selected from a group consisting of: general packet radio service (GPRS), a code division multiple access (CDMA) protocol, radio frequency identification (RFID), a Bluetooth protocol, a subscriber identity module (SIM) card, and a smart card.

19. A program product stored on a computer readable medium, which when executed, enables a computer system to enhance awareness of physical location within a community, the computer readable medium comprising program code for:
detecting a device affiliated with a member of the community, when the device is within a specified proximity to a user; and
notifying the user of the detection of the member within the specified proximity.

20. The program product of claim 19, wherein at least one of the detecting and notifying includes using at least one selected from a group consisting of: general packet radio service (GPRS), a code division multiple access (CDMA) protocol, radio frequency identification (RFID), a Bluetooth protocol, a subscriber identity module (SIM) card, and a smart card.

21. A method for deploying an application for enhancing awareness of physical location within a community, comprising:
providing a computer infrastructure being operable to:
detect a device affiliated with a member of the community, when the device is within a specified proximity to a user; and
notify the user of the detection of the member within the specified proximity.
